(19) United States
(12) Patent Application Publication
(10) Pub. No.: US 2018/0035056 A1
(43) Pub. Date: Feb. 1, 2018

(54) TRACKING A TARGET WITH AN IMAGING SYSTEM

(71) Applicant: HEWLETT-PACKARD DEVELOPMENT COMPANY, L.P., HOUSTON, TX (US)

(72) Inventor: DINESH JINDAL, DOWNERS GROVE, IL (US)

(21) Appl. No.: 15/542,870

(22) PCT Filed: Apr. 24, 2015
(86) PCT No.: PCT/US2015/027468

§ 371 Date: Jul. 11, 2017

(51) Int. Cl. H04N 5/232; G03B 17/56

(52) U.S. Cl. CPC H04N 5/23296; H04N 5/23212; H04N 5/23293; G03B 17/561

(57) ABSTRACT

A method and system are provided for tracking a target with an imaging system. An example of a method includes activating a transmitter on the target. A detector system is activated on the imaging system. A signal from the transmitter is received at the detector system and an imaging device is moved to point at the transmitter.

### BACKGROUND

Photographic systems use an imaging cameraman or photographer to watch through a viewfinder and reposition an imaging device to track the movement of a subject. Generally, one person is used for each imaging device.

### DESCRIPTION OF THE DRAWINGS

Certain exemplary examples are described in the following detailed description and in reference to the drawings, in which:

FIG. 1 is a schematic drawing of an example of an imaging system pointing an imaging device at a target that has an attached transmitter;

FIG. 2 is a close up view of the imaging system, according to an example;

FIG. 3 is a schematic view of an example of a determination of the direction to the transmitter;

FIG. 4 is a schematic view of an example technique that may be used to point the imaging system at a transmitter;

FIG. 5 is an example of using the intensity of an infrared, or other optical, signal at each of the detectors, and to point the imaging system at the transmitter

FIG. 6 is a block diagram of an example control system for an imaging system; and

FIG. 7 is a process flow diagram of an example of a method for using a transmitter on a target to control the directional targeting of an imaging system.

### DETAILED DESCRIPTION

Examples described herein provide a system to keep an imaging system pointed at a target with an attached transmitter based on radio signals received from the target. The system can include an imaging system, a control system, a transmitter, receivers, and motion apparatus. The motion apparatus includes mechanisms for panning and tilting the imaging device. The control system may also provide distance information to the imaging device to assist in focusing the imaging device at a target having the transmitter attached. The field-of-view can also be controlled to have the target occupy a consistent amount of the image size, this may be accomplished by zooming the imaging device in or out

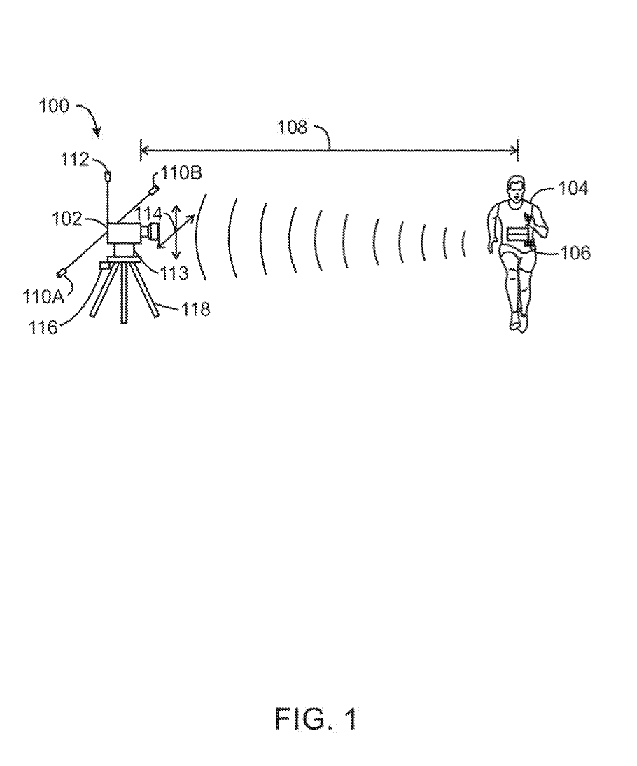

FIG. 1 is a schematic drawing of an example of an imaging system 100 pointing an imaging device 102 at a target 104 that has an attached transmitter 106. As used herein, the imaging device 102 may include a digital still camera, a digital movie camera, a film still camera, or a film movie camera. The transmitter 106 may be a small radio or infrared unit that is associated with the target 104. For example, the transmitter 106 may be carried by the target 104, attached to clothing, or installed inside an object, such as a ball, a car, and the like. The type of transmitter 106, e.g., infrared or radio signal, may depend on the desired use. For example, if the target 104 is expected to be at a longer distance 108 from the imaging system 100, a radio signal device may be used as the transmitter 106. If the imaging system 100 is at a shorter distance 108 to the target 104, an infrared emitter may be used as the transmitter 106. Further, a radio signal device may be selected as the transmitter 106 if it is going to be hidden from view, such as in a pocket or an object.

The imaging system 100 includes the imaging device 102, as well as a number of other units to point the imaging device 102 at the target 104. The additional units can include horizontal detectors 110A and 110B and a vertical detector 112. Although the detectors 110A, 110B, and 112 are shown in particular angular relations to the imaging device 102, e.g., horizontally and vertically, it can be noted this is merely a convenience for the panning and lifting motions. The detectors 110A, 110B, and 112 can be placed at any number of angles, so long as the imaging system 100 is calibrated to move the imaging device 102 and track the transmitter.

A motion system 113 can be used to move 114 the imaging device 102. Under the direction of a control system 116 the imaging device 102 is moved to track the transmitter 106 and, thus, the target 104. These units are discussed in further detail in subsequent figures. The imaging device 102 can be supported in any number of ways. For example, a tripod 118 can be used to hold the imaging device 102.

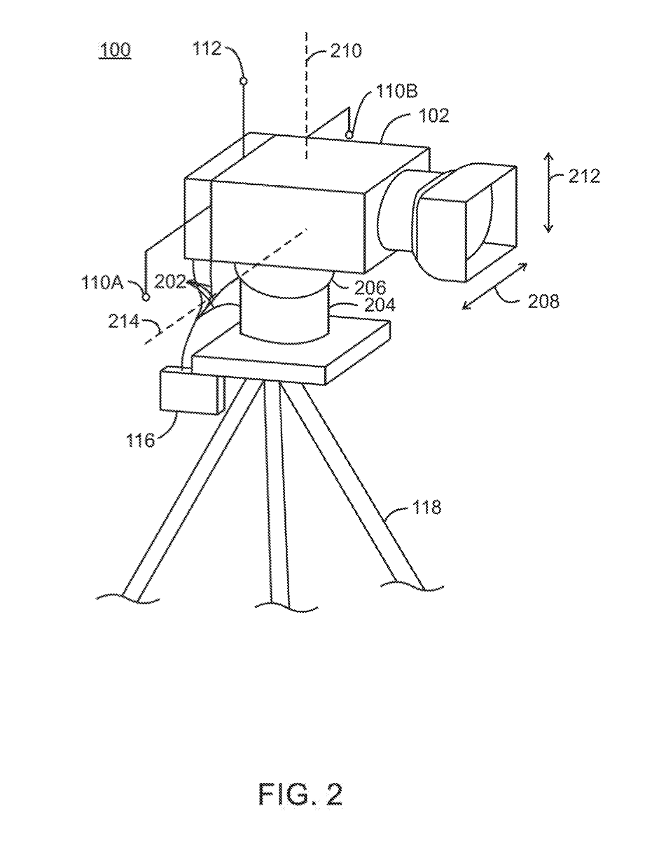

FIG. 2 is a close up f the imaging system 100, according to an example. Like numbered items are as described with respect to FIG. 1. Control lines 202 couple the control system 116 to the imaging device 102, the detectors 110A, 110B, and 112, a panning motor 204, and a tilting motor 206.

Panning 208 the imaging device 102 involves rotating the imaging device 102 around a vertical axis 210, for example, in a horizontal plane that includes the imaging device 102 and the transmitter 106 on the target 104 being imaged. Tilting the imaging device 102 involves rotating the imaging device 102 around a horizontal axis 214 through the imaging device 102, for example, in a vertical plane that includes the imaging device 102 and the transmitter 106 on the target 104 being imaged. Focusing the imaging device may be performed by using a distance determination made by the control system 116. Alternative, an autofocusing system located in the camera may be used.

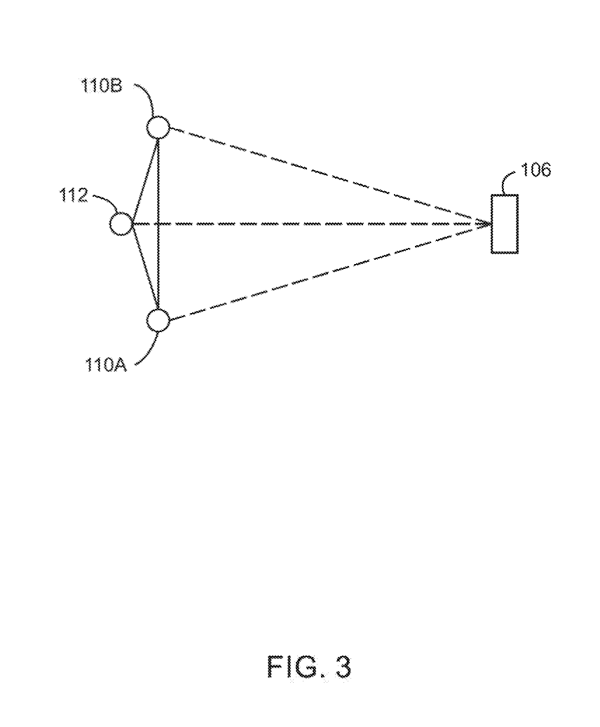

FIG. 3 is a schematic view of an example of a determination of the direction to the transmitter 106. Like numbered items are as described with respect to FIG. 1. The transmitter 106 and the detectors 110A, 110B, and 112, may work or multiple channels or frequencies or codes that can be matched. This may allow multiple imaging systems to shoot the same subject or different imaging systems in the same area to image different targets without interference.

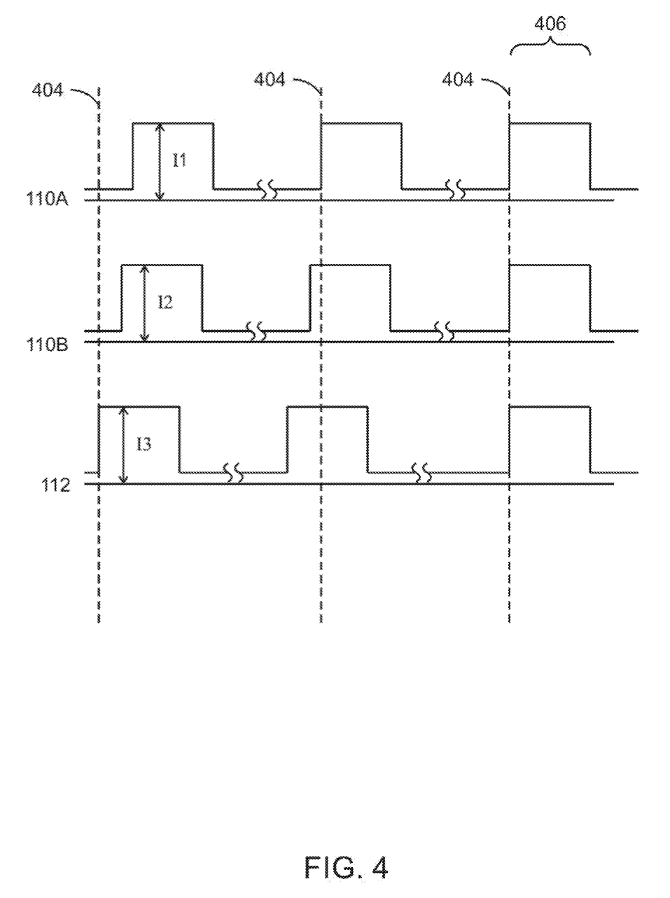

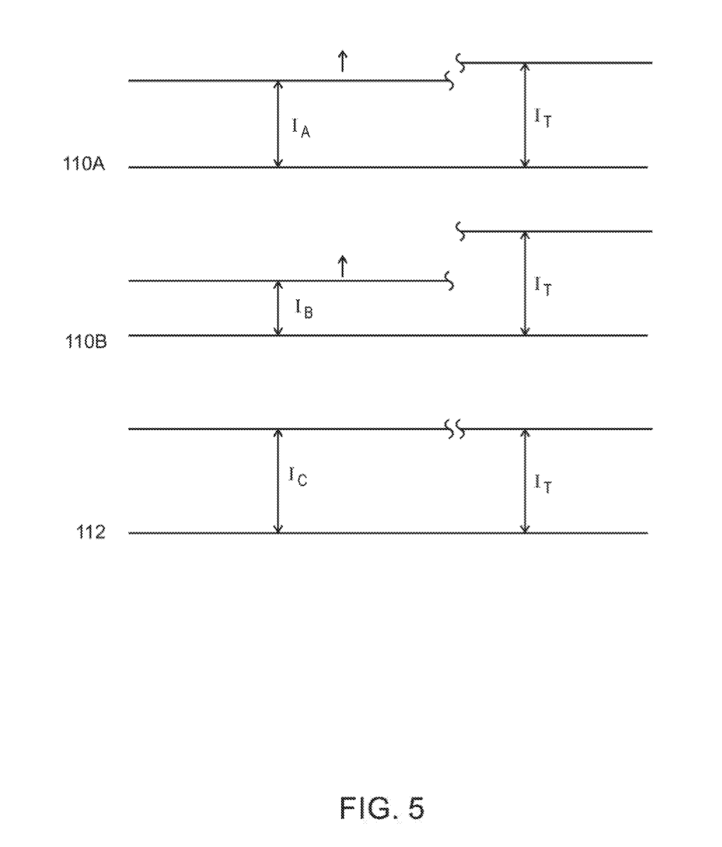

The determination of the direction to the target can be made by any number of techniques. Generally, the determination involves comparing the signal received from the transmitter 106 at each of the detectors 110A, 1108, and 112, and then adjusting the direction of the imaging system 100 based on the results. In some cases, the direction of the imaging system 100 is adjusted to provide a matched signal at each detector 110A, 110B, and 112. This is discussed further with respect to FIGS. 4 and 5.

FIG. 4 is a schematic view of an example technique that may be used to point the imaging system 100 at a transmitter 106. Like numbered items are as described with respect to FIG. 1. In this example, the transmitter 106 broadcasts a pulsed radio signal, and the plots indicate the signal intensity at each of the detectors 110A, 110B, and 112, e.g., I₁, I₂, and I₃, respectively. A leading edge of a pulse 404 may be used to determine phase differences between each of the signals. A phase locked loop may be used to generate an error signal that can be used to adjust the direction of the imaging system 100 until all three antenna are in phase 406. The pulse sequence may be used to identify the unit, so that multiple units may be used in the same area. In some examples, the frequency of the transmission may be specific to particular units, so that multiple camera systems may be used in the same area.

Any number of mathematical techniques may be used to determine the distance le the target in this example. For example, the ratio of the movements used to get the antennas in phase to the value of the phase error signal may be used to determine the distance to the transmitter. Targets that are farther from the imaging system 100 may use smaller corrections for a certain value of the error signal in comparison to targets that are closer. Other techniques may use the intensity of the signal to determine the distance.

FIG. 5 is an example of using the intensity of an infrared, or other optical, signal at each of the detectors 110A, 110B, and 112 to point the imaging system 100 at the transmitter 106. In this case, the intensity of the signals, I_{A}, I_{B}, and I_{C}, at each of the three detectors 110A, 110B, and 112, respectively, can be normalized to a single intensity value, I_{T}, by moving the imaging system 100. In this example, the distance to the target may be calculated based on intensity of the signals.

Although the optical system may use an analog servo system, a pulsed optical system may be used, similar to the radio signal above. In this example, the direction adjustment may be made by comparing the phase of the optical signals, as described with respect to the pulsed radio signals. As for the radio system, the pulse sequence may be used to identify specific units.

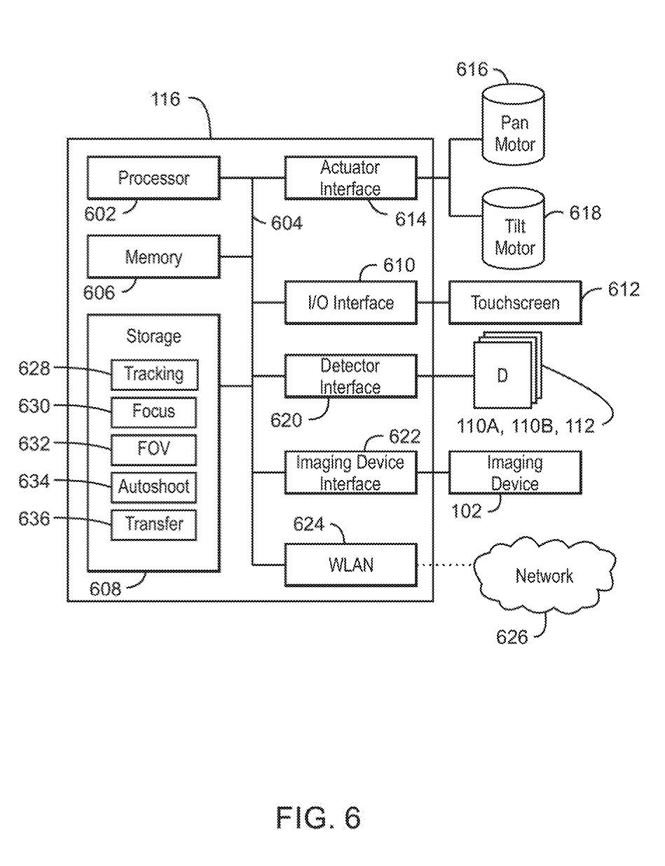

FIG. 6 is a block diagram of an example control system 116 for an imaging system 100. Like numbered items are as described with respect to FIG. 1. This control system 116 controls the movement of the imaging device 102 based upon the signal from the detectors 110A, 110B, and 112. In some examples, the control system 116 is a proprietary computing device, a general computing device, a laptop computer, a desktop computer, and the like. As used herein, a proprietary computing device is a unit specifically designed to provide the targeting functionality. The control system 116 includes at least one processor 602. The processor can be a single, core processor, a multicore processor, a processor cluster, and the like. The processor 602 is coupled to other units through a bus 604. The bus 604 can include PCIe interconnects, PCIx, or any number of other suitable technologies.

The processor 602 can be linked through the bus 604 to a system memory 606. The system memory 606 can include random access memory (RAM), including volatile memory such as static random-access memory (SRAM) and dynamic random-access memory (DRAM), non-volatile memory such as resistive random-access memory (RRAM), and any other suitable memory types or combinations thereof. The control system 116 can include a tangible, non-transitory, machine-readable storage medium, such as a storage device 608 for the long-term storage of instructions and data, including the operating programs and data such as user files. The storage device 608 may include a hard dive, a solid state drive, and the like.

The processor 602 may be coupled through the bus 604 to an I/O interface 610. The I/O interlace 610 may be coupled to any suitable type of I/O devices, including input devices, such as a touch screen 612, a mouse, a keyboard, a display, and the like. The I/O devices may also include external storage devices, such as hard drives, flash drives, and the like. The touch screen 612 may be used for the entry of control parameters to the control system 116.

An actuator interface 614 may be coupled through the bus 604 to the processor 602. The actuator interface 614 may include drivers to provide signals to drive the position of a pan motor 616 and a tilt motor 618. Feedback signals from the motors 616 and 618 may be provided to the actuator interface 614, for example, from optical encoders, Hall effect sensors, and the like. The feedback signals may be used to move the imaging system 100 to point at a particular position, for example, in the direction of origin of a signal.

A detector interface 620 may receive and process signals from the detectors 110A, 110B, and 112. The detector interface 620 may be, for example, a three channel radio signal interface for couple to antennas. In some examples, the detector interface 620 may be a circuit designed to interface with optical detectors such as phototransistors.

An imaging device interface 622 may provide the control system 116 with a command and data interface to an imaging device 102. The imaging device interface 622 may be a general purpose interface, such as a USB interface, an Ethernet interface, an Infiniband interface, a Firewire interface and the like. In some examples, the imaging device interface 622 may be an interface designed to work with a particular type of imaging device 102. The imaging device interface 622 may be selected depending on the amount of imaging data being transfer to the control system 116. In examples in which the imaging device 102 is a high definition video camera, a high bandwidth interface, such as an Infiniband interface may be used. In examples in which the imaging device 102 is a digital still camera, a USB interface may be sufficient. Further, in examples in which the imaging device 102 is a film camera, the imaging device interface 622 may be a proprietary bus, for example, used for shutter and film advance control.

The control system 116 can also include a wireless local area network interface controller (WLAN) 624, for connecting the control system 116 to a network 626. In some examples, the network 626 may be a local control computer, an enterprise server network, a local area network (LAN), a wide-area network (WAN), or the Internet, for example.

The control system 116 can include logic 602 to perform various functions for the imaging system 100. For example, the storage device 608 may include a number of code modules to direct the processor. The control system 116 may also include hard wired logic to perform functions in addition to or instead of the code modules in the storage device 608.

A tracking module 628 can include code to point the imaging device 102 at a target. This may include, for example, keeping the imaging device 102 tracking the target during fast motion of the target.

A focusing module 630 can provide distance information to the imaging device 102 to be used for focusing. In some examples, the focusing may be performed by the imaging device 102 itself. In these examples, the focusing module may be used merely to instruct the imaging device 102 to focus on the target.

A field-of-view (FOV) module 632 may be used to set the relation of the target to the total image captured by the imaging device 102. The FOV module 632 may allow a user to set the relative location of the subject in the frame, or example, in the center, lower left, right, and the like. Further, the FOV module may determine the size of the area to be imaged, for example, relative to the target. In a group of people with one person carrying the transmitter, the area can be large to encompass ail persons. Further, if a target carrying the transmitter is on the left lower portion of the action to be captured, the location can be customized accordingly. For example, the customization may also include a distance to cover in each direction from the target point. If a transmitter is fitted on a person's foot, the area to cover may be extended above the transmitter to capture the person.

An autoshoot module 634 may be used to control the timing of the image capture. This may include a sequence entered by a user, for example, using the touchscreen, and external program, or a message received from a system of the network 626. The image capture may include a single image, a series of images, or a start and stop time for a video recording.

A transfer module 636 may be used to obtain image data from an imaging device 102. This may be useful for providing additional storage to the imaging device 102. Further, this function may be used to obtain image data from the imaging device 102 and sending the data to a system located on the network 626.

It is to be understood that the block diagram of FIG. 6 is not intended to indicate that the control system 116 is to include all of the components shown in FIG. 6. Rather, the control system 116 can include fewer or additional components not illustrated in FIG. 6. For example, the control system 116 may include a high speed network coupling, such as an optical fiber or Ethernet connection. Further, the control system 116 may omit the I/O interface and touchscreen. In this, example, an external system, such as a laptop, may provide commands through the network interface.

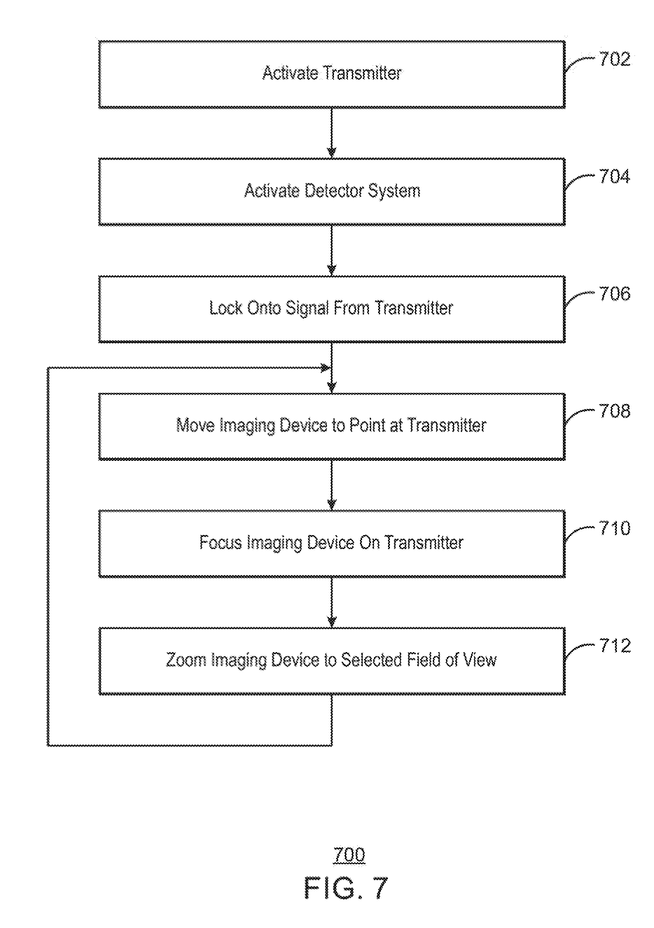

FIG. 7 is a process flow diagram of an example of a method 700 for using a transmitter on a target to control the directional targeting of an imaging system. The method 700 begins at block 702 with The activation of a transmitter associated with a target, for example, as discussed with respect to FIG. 1. At block 704, a detector system is activated to determine a direction to the signal from the transmitter, for example, as described with respect to FIG. 3, The detector system can include multiple antennas to determine the direction from a radio signal, for example, as discussed with respect to FIG. 4, or optical detectors, for example, as discussed respect to FIG. 5.

At block 706, a control system can lock onto a signal from the transmitter. For example, an imaging system may be to work with a specific transmitter signal and to ignore other transmitters that may be operating in proximity to the control system.

At block 708, the control system may move the imaging device to point at the transmitter. As discussed with respect to FIG. 6, this may include setting a custom offset from the center of the image, or example, if the transmitter is located farther away from the action. At block 710, the imaging device may be focused on the target either by passing distance information from the control system to the camera, or by triggering the focusing system built into the camera.

At block 712, the control system may zoom the imaging device to the selected field of view. As discussed herein, this may include a larger or smaller area around a target. In an example, this may be changed during recording of an image, for example, by a director changing a control.

It is to be understood that the block diagram of FIG. 7 is not intended to indicate that the method 700 is to include all of the actions shown in FIG. 7. Rather, the method 700 can include fewer or additional components not illustrated in FIG. 7. For example, the method 700 may include an auto-shooting function to trigger the capture of the image data at a particular point in time, or using a preset start and stop time. Further, the control system 116 may omit the focusing function of block 710. In this example, the imaging device may focus itself on the target while capturing the imaging data after a manual trigger.

While the present techniques may be susceptible to various modifications and alternative forms, the exemplary examples discussed above have been shown only by way of example. It is to be understood that the technique is not intended to be limited to the particular examples disclosed herein. Indeed, the present techniques include all alternatives, modifications, and equivalents falling within the scope of the present techniques.

What is claimed is:

1. An imaging system, comprising:
an imaging device;
a panning motor;
a tilting motor;
a plurality of detectors; and
a control system, comprising:
a driver for the panning motor;
a driver for the tilting motor; and
logic to detect a signal at the plurality of detectors and adjust the panning motor and the tilting motor to point the imaging device at a transmitter sending the signal.

2. The system of claim 1, comprising an interface to the imaging device, and logic to calculate a distance to the transmitter and focus the imaging device at the distance of the transmitter.

3. The system of claim 1, comprising logic to orient the imaging device at the transmitter by aligning a phase of a pulsed radio signal received at each of the plurality of detectors.

4. The system of claim 1, comprising logic to orient the imaging device at the transmitter by normalizing an intensity for an infrared signal received at each of the plurality of detectors.

5. The system of claim 1, comprising logic to zoom the imaging device to a selected field of view around the transmitter.

6. The system of claim 5, wherein the field of view is determined by an area a target associated with the transmitter occupies in the image.

7. The system of claim 1, comprising a radio transmitter to broadcast a signal to the plurality of detectors.

8. A method of tracking a target with an imaging system, comprising:
activating a transmitter on the target;
activating a plurality of detectors on an imaging system;
detecting a signal from the transmitter at each of the plurality of detectors; and
moving the imaging system to point at the transmitter, based on a comparison between the signals received at each of the plurality of detectors.

9. The method of claim 8, comprising focusing are imaging device on the transmitter.

10. The method of claim 8, comprising zooming an imaging device to a selected field of view.

11. The method of claim 8, comprising downloading image files from an imaging device to a control system.

12. A non-transitory machine readable medium, comprising instructions to direct a processor to:
detect a signal from a transmitter through a plurality of detectors;
determine a direction of origin for the signal; and
adjust a panning motor and a tilting motor to point an imaging device at the transmitter.

13. The non-transitory machine readable medium of claim 12, comprising instructions to direct the processor to trigger the imaging device to record an image.

14. The non-transitory machine readable medium of claim 12, comprising instructions to direct the processor to obtain and store image data from the imaging device.

15. The non-transitory machine readable medium of claim 12, comprising instructions to direct the processor to upload image data to a network.
